(19) United States
(12) Patent Application Publication
(10) Pub. No.: US 2011/0097011 A1
(43) Pub. Date: Apr. 28, 2011

(54) MULTI-RESOLUTION IMAGE EDITING

(76) Inventors: Suk Hwan Lim, Mountain View, CA (US); Xuemei Zhang, Mountain View, CA (US)

(21) Appl. No.: 12/606,822

(22) Filed: Oct. 27, 2009

(51) Int. Cl. G06K 9/40; G06K 9/32

(52) U.S. Cl. 382/264; 382/299; 382/275

(57) ABSTRACT

Visual elements of a first image are changed in accordance with an image editing process to produce an edited high-resolution image and visual elements of a second image are modified in accordance with an emulator process to produce a modified low-resolution image. The emulator process produces the modified low-resolution image with visual changes relative to the second image that mimic perceived visual changes made to the visual elements of the first image by the image editing process to produce the edited high-resolution image. The emulator process is built from a set of one or more image enhancement processes in accordance with an optimization process.

### BACKGROUND

Individuals and organizations are rapidly accumulating large collections of digital image content, including still images, text, graphics, animated graphics, and full-motion video images. This content may be presented individually or combined in a wide variety of different forms, including documents, catalogs, presentations, still photographs, commercial videos, home movies, and metadata describing one or more associated digital content files. As these collections grow in number and diversity, individuals and organizations increasingly will require systems and methods for organizing and presenting the digital content in their collections. To meet this need, a variety of different systems and methods for organizing and presenting digital image content have been proposed. Image editing is a fundamental component of most image organization and presentation systems. Image editing refers to the process of modifying a source image to create an output image. Image editing may involve applying one or more image enhancement processes (e.g., sharpening, blurring, brightening, darkening, and color enhancing) that change visual elements of the source image. Many image enhancement processes, however, can take considerable time to complete, making it cumbersome for the type of real-time interaction that is needed to achieve high usability and user satisfaction.

What are needed are improved systems and methods for editing images.

### DESCRIPTION OF DRAWINGS

FIG. 1 is a block diagram of an embodiment of an image editing system.

FIG. 2 is a flow diagram of an embodiment of a method of multi-resolution image editing.

FIG. 3 is a flow diagram of an embodiment of a method of multi-resolution image editing.

FIG. 4 is a flow diagram of an embodiment of a method of deriving an image editing process and an emulator process from a parameterized image editing process.

FIG. 5 is a flow diagram of an embodiment of a method of building embodiments of an emulator process.

FIG. 6 is a flow diagram of an embodiment of the emulator building method of FIG. 5.

FIG. 7 is a block diagram of an embodiment of a computer system that incorporates an embodiment of the image processing system of FIG. 1.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

### I. DEFINITION OF TERMS

An “image” broadly refers to any type of visually perceptible content that may be rendered on a physical medium (e.g., a display monitor or a print medium). Images may be complete or partial versions of any type of digital or electronic image, including: an image that was captured by an image sensor (e.g., a video camera, a still image camera, or an optical scanner) or a processed (e.g., filtered, reformatted, enhanced or otherwise modified) version of such an image; a computer-generated bitmap or vector graphic image; a textual image (e.g., a bitmap image containing text); and an iconographic image.

The term “visual quality feature” means an attribute or property of an image that affects the perceived visual quality or appeal of the areas or regions of the image that contain that feature. Exemplary visual quality features include, but are not limited to, blur, noise, texture, colorfulness, and specular highlights.

The term “pixel resolution” (or simply “resolution”) refers to a count of the pixels in an image. The pixel count may be expressed, for example, as a total pixel count or as a product of the horizontal and vertical dimensions of the array of pixels corresponding to the image.

A “computer” is any machine, device, or apparatus that processes data according to computer-readable instructions that are stored on a computer-readable medium either temporarily or permanently. A “computer operating system” is a software component of a computer system that manages and coordinates the performance of tasks and the sharing of computing and hardware resources. A “software application” (also referred to as software, an application, computer software, a computer application, a program, and a computer program) is a set of instructions that a computer can interpret and execute to perform one or more specific tasks. A “data file” is a block of information that durably stores data for use by a software application.

A “physical processing device” is any machine, device, or apparatus that processes data. Exemplary types of physical processing devices are computers and application-specific integrated circuits (ASICs).

A “predicate” is a conditional part of a rule. A “termination predicate” is a predicate that conditions a termination event on satisfaction of one or more criteria.

As used herein, the term “includes” means includes but not limited to, and the term “including” means including but not limited to. The term “based on” means based at least in part on.

### II. MULTI-RESOLUTION IMAGE EDITING

The embodiments that are described herein enable realtime user image editing interactions by presenting realtime image editing results that accurately reflect the visually perceptible effects of the image editing operations on original source images. In these embodiments, realtime performance is achieved by modifying low-resolution versions of the source images in accordance with low-resolution versions of the user-selected image editing operations for the original (high-resolution) source images. The low-resolution versions of the image-editing operations modify the low-resolution version of the source images in ways that accurately convey the visual modifications made by the user-selected image editing operations so that the user can quickly determine whether or not the user-selected image editing operations will produce the desired visual effects in the source images. The original source images themselves may be processed with the user-selected image editing processes either concurrently or at a later time.

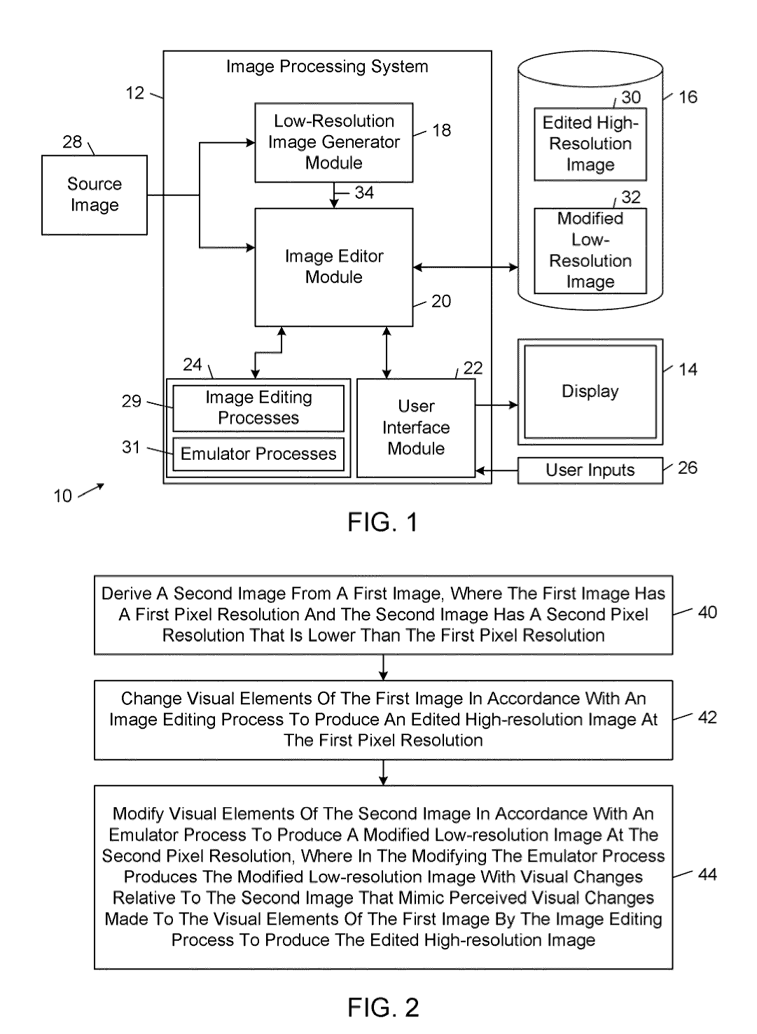

FIG. 1 shows an embodiment of an image editing system 10 that includes an image processing system 12, a display 14, and a data storage device 16. The image processing system 12 includes a low-resolution image generator module 18, an image editor module 20, a user interface module 22, and a set of image enhancement processes 24. In some embodiments, the user interface corresponds to the user interface of the image collage authoring system described in U.S. patent application Ser. No. 12/366,616, which was filed on Feb. 5, 2009. The modules of the image processing system 12 are not limited to a specific hardware or software configuration, but rather they may be implemented in any computing or processing environment, including in digital electronic circuitry or in computer hardware, firmware, device driver, or software.

In operation, the user interface module 22 generates a user interface, which is displayed on the display 14. The user interface enables a user to enter user inputs 26 that specify instructions for editing a source image 28. The image editor module 20 applies one or more of the image enhancement processes 24 to the source image 28 in accordance with the user instructions to produce an edited high-resolution image 30 and a modified low-resolution image 32. The edited high-resolution image 30 corresponds to an edited version of the source image 28, where the edited high-resolution image 30 is produced based on one or more of the image editing processes 29. The modified low-resolution image 32 corresponds to a modified version of a reduced resolution version 34 of the source image 28 that is produced by the low-resolution image generator module 18, where the modified low-resolution image 32 is produced based on one or more emulator processes 31 that respectively correspond to the image editing processes 29 that were applied to the source image 28. The user interface module 22 presents the modified low-resolution image 32 on the display in realtime so that the user can rapidly determine if the selected image editing operations will produce the desired visual effect.

In the illustrated embodiments, the image processing system 12 outputs the edited high-resolution image 30 by storing it in a database on the data storage device 16, and outputs the modified low-resolution image 32 by storing it in the data storage device 16 and rendering it in the user interface that is presented on the display 14. In other embodiments, the image processing system 12 outputs one or both of the edited high-resolution image 30 and the modified low-resolution image 32 by rendering them on a print medium (e.g., paper).

FIG. 2 shows an embodiment of a method by which the image processing system 12 produces the edited high-resolution image 30 and the modified low-resolution image 32 from the source image 28. In accordance with this method, the low-resolution image generator module 18 derives a second image (i.e., the reduced-resolution image 34 in the illustrated embodiment) from a first image (i.e., the source image 28 in the illustrated embodiment), where the source image 28 has a first pixel resolution and the reduced-resolution image 34 has a second pixel resolution that is lower than the first pixel resolution (FIG. 2, block 40). The image editor module 20 changes visual elements of the source image 28 in accordance with an image editing process 29 to produce the edited high-resolution image 30 at the first pixel resolution (FIG. 2, block 42). The image editor module 20 modifies visual elements of the low-resolution image 34 in accordance with an emulator process 31 to produce the modified low-resolution image 32 at the second pixel resolution. In this process, the emulator process produces the modified low-resolution image 32 with visual changes relative to the low-resolution image 34 that mimic perceived visual changes made to the visual elements of the source image 28 by the image editing process to produce the edited high-resolution image 30 (FIG. 2, block 44).

In some embodiments, the reduced-resolution image 34 corresponds to a downsampled and smoothed version of the source image 28. In other embodiments, the reduced-resolution image 34 corresponds to a photorealistic thumbnail image that is generated in accordance with one or more of the processes described in U.S. Patent Application Publication No. 2008/0134094. As used herein, the term “photorealistic thumbnail image” refers to a reduced-resolution version of an input image that reflects the arrangement, proportions, and local details of the corresponding input image. Photorealistic thumbnail images may contain either reproduced or synthesized elements that subjectively convey the visual appearance of the different visual elements of the corresponding input image without necessarily objectively reproducing the high resolution visual elements. In contrast, a “non-photorealistic thumbnail image” refers to a reduced-resolution version of an input image that purposefully and stylistically modifies local details of visual elements of the input image to focus the viewer's attention in a way that communicates information.

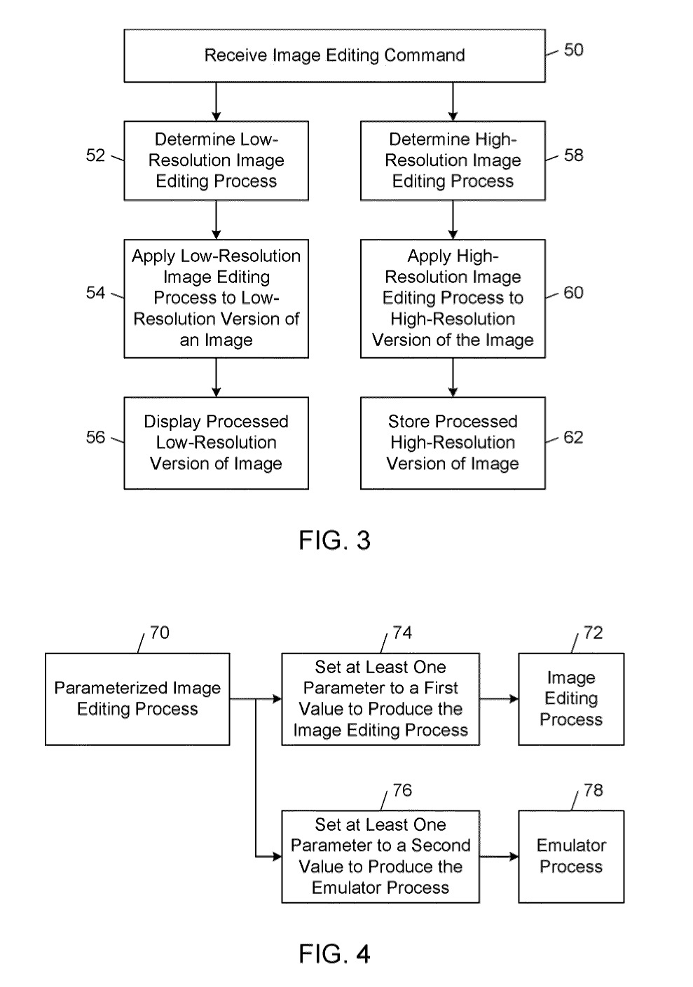

FIG. 3 shows an embodiment of an exemplary use model for the image editing system 10. In accordance with this method, the user interface module 22 receives an image editing command from the user (FIG. 3, block 50). The image editor module 20 determines a low-resolution image editing process that corresponds to the image editing command (FIG. 3, block 52), applies the low-resolution image editing command to the low-resolution version of an image (e.g., the low-resolution image 34 derived from the source image 28) (FIG. 3, block 54), and displays the processed low-resolution version of the image on the display 14 (FIG. 3, block 56). The image editor module 20 also determines a high-resolution image editing process that corresponds to the image editing command (FIG. 3, block 58), applies the high-resolution image editing process to the high-resolution version of the image (e.g., the source image 28) (FIG. 3, block 60), and stores the processed high-resolution version of the image in the data storage device 16 (FIG. 3, block 62).

FIG. 4 shows an embodiment by which image editing processes 29 and the corresponding emulator processes 31 are derived from parameterized image editing processes. In accordance with this embodiment, the process starts with a parameterized image editing process 70, which includes at least one parameter that can be set to different respective pixel-resolution-dependent values that influence how the parameterized image enhancement process changes visual elements of an input image. The at least one parameter is set to a first value to produce the image editing process 72 (FIG. 4, block 74). The at least one parameter is set to a second value (which is different from the first value) to produce the emulator process 76 (FIG. 4, block 76).

In general, there are a wide variety of different image enhancement processes that can be parameterized with pixel-resolution-dependent parameter values. In some embodiments, the parameterized image enhancement processes have one or more spatial terms (e.g., spatial convolution kernels or spatial Gaussian functions) that are parameterized with pixel-resolution-dependent parameter terms. The following are examples of how an existing image processing method can be modified through parameter value changes such that the image processing applied to the low-resolution image accurately imitates the visual effect of the image processing applied to the high-resolution image. Since the image processing is applied to the lower resolution images, it can be completed quickly, enabling the user to perform realtime editing operations on the source image 28.

In one exemplary embodiment, the parameterized image enhancement process includes a pixel-resolution-dependent denoising process that includes processing each pixel i of an input image I(i) in accordance with a function given by:

$${I}^{*} ( i ) = \frac{1}{{\sum }_{j} g ( I ( i ) - I ( i - j ) ) \cdot h ( j )} {\sum }_{j} I ( i - j ) \cdot g ( I ( i - j ) - I ( i ) ) \cdot h ( j ) \qquad ( 1 )$$

where I*(i) is a value of a pixel i of a denoised image produced from the input image I(i) by the denoising process, h(j) is a convolution kernel, and g(I(i)−I(i−j)) is a photometric distance function, and at least one of h(j) and g(I(i)−I(i−j)) is different in the different respective versions of the parameterized image enhancement process corresponding to the image editing process and the emulator process.

The photometric distance term g( ) in equation (1) achieves selective denoising of pixels without blurring edges. The photometric distance term g( ) essentially determines whether the differences between neighboring pixels are due to the actual image contents (e.g. edges) or noise. In some embodiments, the photometric distance term g( ) is a Gaussian function with a fixed cut-off parameter T as defined in equation (2):

$$g ( Δ I ) = exp ( - \frac{Δ {I}^{2}}{2 {T}^{2}} ) \qquad ( 2 )$$

In some of these embodiments, the cutoff parameter T is set to different respective values for the high- and low-resolutions versions of the denoising image enhancement process. The value of the cutoff parameter T typically is set to a lower value (T_{LowRes}) for the low-resolution version of the denoising process and is set to a higher value (T_{HighRes}) for the high-resolution version of the denoising process. These settings account for the observation that the down-sampling used to produce the low-resolution image 34 typically causes both the local contrast of the image and the noise strength to be reduced simultaneously. The values of T_{LowRes} and T_{HighRes} typically are determined empirically.

In some embodiments, the convolution kernel h( ) in equation (1) is a Gaussian kernel as defined in equation (3)

$$h ( j ; σ ) = \frac{1}{2 πσ} exp ( - \frac{{j}^{2}}{2 {σ}^{2}} ) \qquad ( 3 )$$

where σ determines the width of the Gaussian kernel. In some embodiments, when the high-resolution input image is filtered with a Gaussian kernel having a width of σ_{HIGH}, then the low-resolution version of the input image is filtered with a Gaussian kernel having a width σ_{LOW}=σ_{HIGH}/DS, where DS is a pixel-resolution-dependent parameter. In some embodiments, DS is equal to the down-sampling factor that is applied by the low-resolution image generator module 18 to produce the low-resolution image 34. In other embodiments, DS has a value that is equal to the ratio of the pixel resolution of the low-resolution image and the pixel resolution of the high-resolution image. In some embodiments, the spatial support of the Gaussian kernel (h( ) is reduced to lower the computational complexity.

Other spatial filtering techniques (e.g., sharpening) readily can be parameterized in ways that are analogous to the denoising process described above to produce a high-resolution image editing process that is applied to the source image 28 and a low-resolution emulator process that is applied to the low-resolution version 34 of the source image 28.

In another parameterized image enhancement embodiment, the image editing process is a local contrast enhancement process and the corresponding emulator process is a local contrast enhancement process with different parameters. In these embodiments, the local contrast enhancement is performed in a two step process: first, a mask is created by smoothing the image; then, the pixel intensity values in the mask are used to select the appropriate contrast enhancement curve from a class of such curves (see, e.g., Nathan Moroney, “Local Color Correction Using Non-Linear Masking”, IS&T/SID Eighth Color Imaging Conference, 2000, pp. 108-111; also see U.S. Pat. No. 6,813,041). The mask for the low-resolution version of the source image is tuned in a pixel-resolution-dependent way so that the low-resolution local contrast enhancement on the low-resolution image accurately imitates the process of local contrast enhancement on the full-resolution source image. In some embodiments, smoothing is performed with the following Gaussian kernel:

I*(i)=ΣⱼI(i−j)·h(j) (4)

where h( ) is given by equation (3). In these embodiments, the width (σ) of the kernel is pixel-resolution-dependent in order to avoid problems of insufficient brightening/darkening in the low-resolution version of the source image. In some exemplary embodiments, the width of the kernel for the low-resolution version σ_{LOW} is set to a value given by σ_{Low}=σ_{HIGH}/DS, where DS is a pixel-resolution-dependent parameter. In some embodiments, DS is equal to the down-sampling factor that is applied by the low-resolution image generator module 18 to produce the low-resolution image 34. In other embodiments, DS is equal to the ratio of the pixel resolution of the low-resolution image and the pixel resolution of the high-resolution image.

In some embodiments, the image editing process 29 and the corresponding emulator process 31 correspond to different respective image enhancement processes that produce similar visually perceptible effects in the source image 28 and the low-resolution version 34 of the source image 28. In one example of this type, the image editing process is a local contrast enhancement process and the corresponding emulator process is an image sharpening process. In another example of this type, the image editing process is a bilateral filtering process and the corresponding emulator process is an image smoothing process. In each of these embodiments, the different high-resolution and low-resolution image enhancement processes are designed so that similar visually perceptible effects are produced at the first and second pixel resolutions

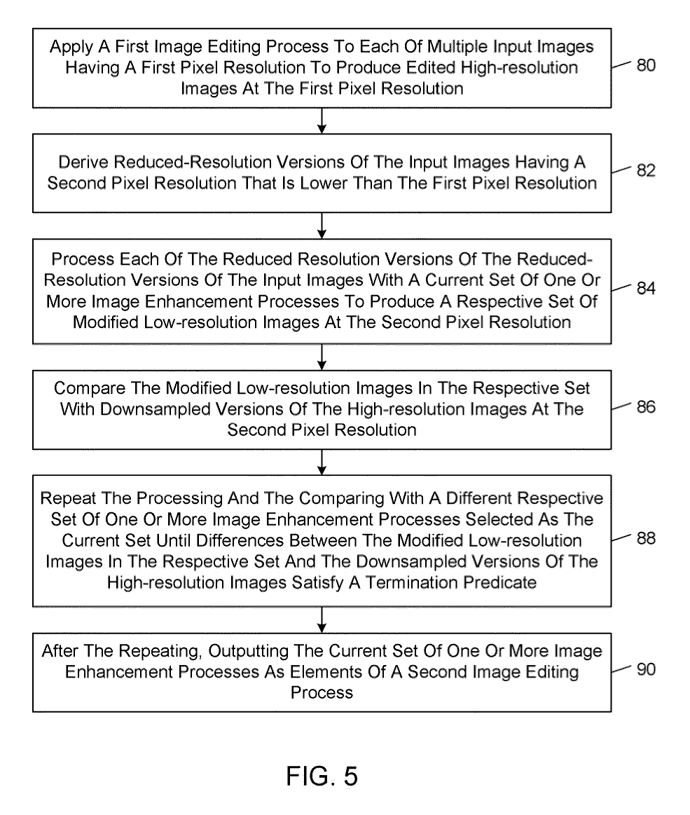

FIG. 5 shows an embodiment of a method of building an embodiment of the emulator process that produces the modified low-resolution image 32 with visual changes relative to the reduced-resolution version 34 of the source image 28 that mimic the perceived visual changes made to the visual elements of the source image 28 by the image editing process to produce the edited high-resolution image 30. The image editing process typically is defined by a first set of one or more image enhancement functions and the emulator process typically is defined by a second set of one or more image enhancement functions that is different from the first set of image enhancement functions. In some embodiments, the first set and the second set consist of different respective numbers of the image enhancement functions.

In accordance with the embodiment of FIG. 5, a first image editing process is applied to each of multiple input images having a first pixel resolution to produce edited high-resolution images at the first pixel resolution (FIG. 5, block 80). Reduced-resolution versions of the input images having a second pixel resolution that is lower than the first pixel resolution are derived (FIG. 5, block 82). Each of the reduced resolution versions of the input images are processed with a current set of one or more image enhancement processes to produce a respective set of modified low-resolution images at the second pixel resolution (FIG. 5, block 84). The modified low-resolution images in the respective set are compared with downsampled versions of the edited high-resolution images at the second pixel resolution (FIG. 5, block 86). The processing (FIG. 5, block 84) and the comparing (FIG. 5, block 86) are repeated with a different respective set of one or more image enhancement processes selected as the current set until differences between the modified low-resolution images in the respective set and the downsampled versions of the edited high-resolution images satisfy a termination predicate (FIG. 5, block 88). After the repeating, the current set of one or more image enhancement processes are output as elements of a second image editing process (FIG. 5, block 90).

In some embodiments, the termination predicate corresponds to a minimization of an aggregate measure of the differences between the modified low-resolution images and the downsampled versions of the edited high-resolution images at the second pixel resolution.

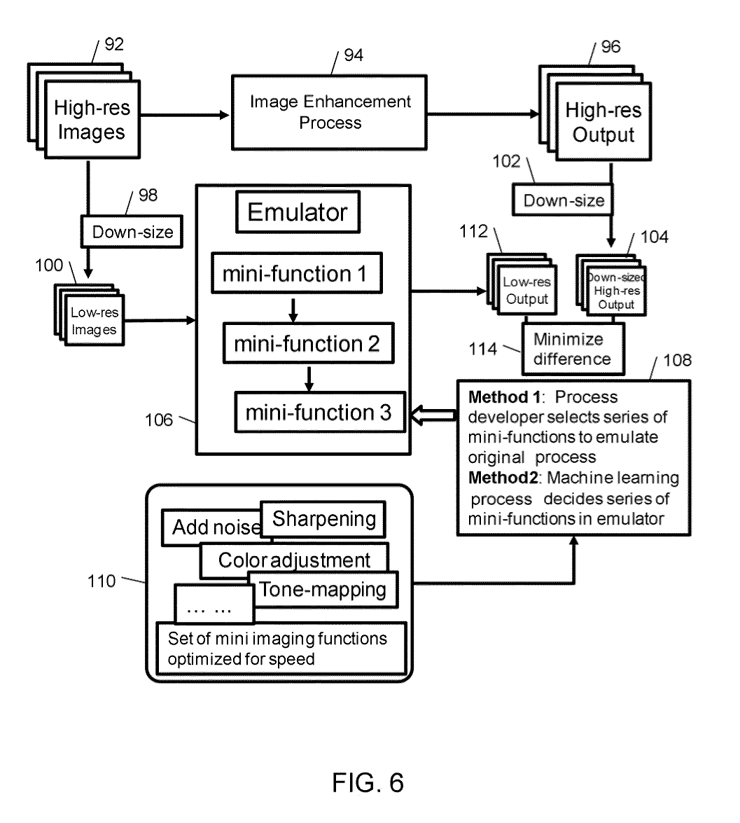

FIG. 6 shows an exemplary embodiment of the method of FIG. 5. In this embodiment, high-resolution images 92 are processed by an image enhancement process (FIG. 6, block 94) to produce high-resolution output images 96. The high-resolution images 92 are downsized (FIG. 6, block 98) to produce low-resolution images 100. Similarly, the high-resolution output images 96 are downsized (FIG. 6, block 102) to produce downsized high-resolution output images 104. An emulator process (FIG. 6, block 106) is built by a configuration method (FIG. 6, block 108) to include one or more image enhancement processes (also referred to herein as “mini imaging functions” or “mini functions) that are selected by the process 108 from a set of image enhancement functions 110. The emulator process 106 applies the one or more constituent image enhancement functions (e.g., mini-function 1, mini-function 2, and mini-function 3) to each of the low-resolution images 100, in the order specified by the configuration method 108, to produce the low-resolution output images 112. An optimization process (FIG. 6, block 114) iteratively runs the configuration method 108 through a series of iterations until the different between the low-resolution output images 112 and the down-sized high-resolution output images satisfies a termination predicate. During each of the optimization iterations, the configuration method builds the emulator 106 with a different respective set of one or more of the image enhancement processes 110. In accordance with one embodiment (i.e., Method 1), the process developer selects a series of different sets of one or more of the image enhancement processes 110 from which to build the emulator process 106 during each iteration. In accordance with another embodiment (i.e., Method 2), a machine learning process is programmed to determine the series of different sets of one or more of the image enhancement processes 110 from which to build the emulator process 106 during each iteration.

In some embodiments, the termination predicate corresponds to a minimization of an aggregation of the differences between corresponding ones of the low-resolution out images 112 and the down-sized high-resolution output images 104. The differences between corresponding ones of the low-resolution out images 112 and the down-sized high-resolution output images 104 can be measured in a variety of different ways. In some embodiments, the difference between each pair of images is measured by the difference between the adaptive color histograms of the corresponding ones of the low-resolution out images 112 and the down-sized high-resolution output images 104. In other embodiments, the difference between each pair of images is measured by the difference between vectors of local features respective extracted from the corresponding ones of the low-resolution out images 112 and the down-sized high-resolution output images 104.

### III. EXEMPLARY OPERATING ENVIRONMENT

The source image (see FIG. 1) may correspond to any type of image, including an original image (e.g., a video keyframe, a still image, or a scanned image) that was captured by an image sensor (e.g., a digital video camera, a digital still image camera, or an optical scanner) or a processed (e.g., sub-sampled, filtered, reformatted, enhanced or otherwise modified) version of such an original image.

Embodiments of the image processing system 12 may be implemented by one or more discrete modules (or data processing components) that are not limited to any particular hardware, firmware, or software configuration. In the illustrated embodiments, these modules may be implemented in any computing or data processing environment, including in digital electronic circuitry (e.g., an application-specific integrated circuit, such as a digital signal processor (DSP)) or in computer hardware, firmware, device driver, or software. In some embodiments, the functionalities of the modules are combined into a single data processing component. In some embodiments, the respective functionalities of each of one or more of the modules are performed by a respective set of multiple data processing components.

The modules of the image processing system 12 may be co-located on a single physical processing device or they may be distributed across multiple physical processing devices; if distributed across multiple physical processing devices, these modules and the display 24 may communicate with each other over local wired or wireless connections, or they may communicate over global network connections (e.g., communications over the Internet).

In some implementations, process instructions (e.g., machine-readable code, such as computer software) for implementing the methods that are executed by the embodiments of the image processing system 12, as well as the data they generate, are stored in one or more machine-readable media. Storage devices suitable for tangibly embodying these instructions and data include all forms of non-volatile computer-readable memory, including, for example, semiconductor memory devices, such as EPROM, EEPROM, and flash memory devices, magnetic disks such as internal hard disks and removable hard disks, magneto-optical disks, DVD-ROM/RAM, and CD-ROM/RAM.

In general, embodiments of the image processing system 12 may be implemented in any one of a wide variety of electronic devices, including desktop computers, workstation computers, and server computers.

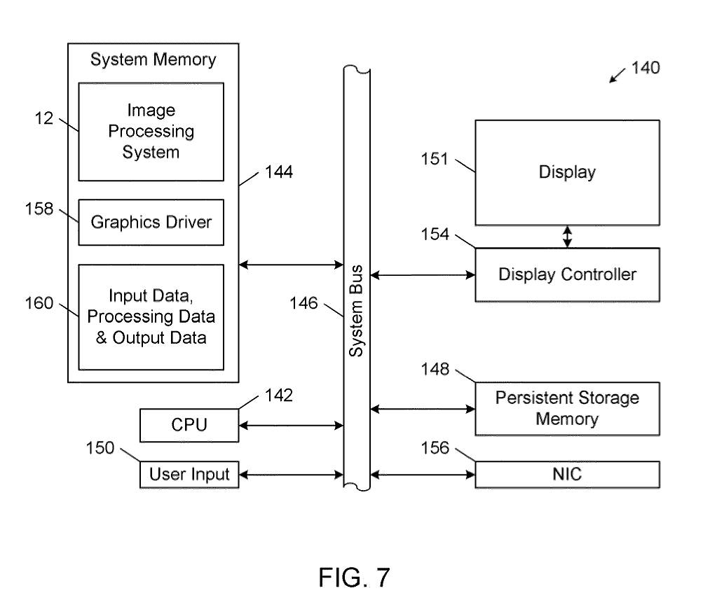

FIG. 7 shows an embodiment of a computer system 140 that can implement any of the embodiments of the image processing system 12 that are described herein. The computer system 140 includes a processing unit 142 (CPU), a system memory 144, and a system bus 146 that couples processing unit 142 to the various components of the computer system 140. The processing unit 142 typically includes one or more processors, each of which may be in the form of any one of various commercially available processors. The system memory 144 typically includes a read only memory (ROM) that stores a basic input/output system (BIOS) that contains start-up routines for the computer system 140 and a random access memory (RAM). The system bus 146 may be a memory bus, a peripheral bus or a local bus, and may be compatible with any of a variety of bus protocols, including PCI, VESA, Microchannel, ISA, and EISA. The computer system 140 also includes a persistent storage memory 148 (e.g., a hard drive, a floppy drive, a CD ROM drive, magnetic tape drives, flash memory devices, and digital video disks) that is connected to the system bus 146 and contains one or more computer-readable media disks that provide non-volatile or persistent storage for data, data structures and computer-executable instructions.

A user may interact (e.g., enter commands or data) with the computer 140 using one or more input devices 150 (e.g., a keyboard, a computer mouse, a microphone, joystick, and touch pad). Information may be presented through a user interface that is displayed to a user on the display 151 (implemented by, e.g., a display monitor), which is controlled by a display controller 154 (implemented by, e.g., a video graphics card). The computer system 140 also typically includes peripheral output devices, such as speakers and a printer. One or more remote computers may be connected to the computer system 140 through a network interface card (NIC) 156.

As shown in FIG. 7, the system memory 144 also stores the image processing system 12, a graphics driver 158, and processing information 160 that includes input data, processing data, and output data. In some embodiments, the image processing system 12 interfaces with the graphics driver 158 (e.g., via a DirectX® component of a Microsoft Windows® operating system) to present a user interface on the display 151 for managing and controlling the operation of the image processing system 12.

### IV. CONCLUSION

The embodiments that are described herein enable realtime user image editing interactions by presenting realtime image editing results that accurately reflect the visually perceptible effects of the image editing operations on original source images. In these embodiments, realtime performance is achieved by modifying low-resolution versions of the source images in accordance with low-resolution versions of the user-selected image editing operations for the original (high-resolution) source images. The low-resolution versions of the image-editing operations modify the low-resolution version of the source images in ways that accurately convey the visual modifications made by the user-selected image editing operations so that the user can quickly determine whether or not the user-selected image editing operations will produce the desired visual effects in the source images. The original source images themselves may be processed with the user-selected image editing processes either concurrently or at a later time.

Other embodiments are within the scope of the claims.

1. A method, comprising:
deriving a second image from a first image, wherein the first image has a first pixel resolution and the second image has a second pixel resolution that is lower than the first pixel resolution;
changing visual elements of the first image in accordance with an image editing process to produce an edited high-resolution image at the first pixel resolution; and
modifying visual elements of the second image in accordance with an emulator process to produce a modified low-resolution image at the second pixel resolution, wherein in the modifying the emulator process produces the modified low-resolution image with visual changes relative to the second image that mimic perceived visual changes made to the visual elements of the first image by the image editing process to produce the edited high-resolution image;
wherein the deriving, the changing, and the modifying are performed by a physical processing device.

2. The method of claim 1, wherein the image editing process and the emulator process correspond to different respective versions of a parameterized image enhancement process that includes at least one pixel-resolution-dependent parameter that influences how the parameterized image enhancement process changes visual elements of an input image, and the at least one pixel-resolution-dependent parameter is set to different values in the different respective versions of the parameterized image enhancement process.

3. The method of claim 2, wherein the parameterized image enhancement process comprises a pixel-resolution-dependent convolution kernel, and the convolution kernel is different in the different respective versions of the parameterized image enhancement process.

4. The method of claim 2, wherein the parameterized image enhancement process comprises a pixel-resolution-dependent Gaussian function, and the Gaussian function is different in the different respective versions of the parameterized image enhancement process.

5. The method of claim 2, wherein the parameterized image enhancement process comprises a pixel-resolution-dependent denoising process that comprises processing each pixel i of the input image I(i) in accordance with a function given by:
$${I}^{*} ( i ) = \frac{1}{{\sum }_{j} g ( I ( i ) - I ( i - j ) ) \cdot h ( j )} {\sum }_{j} I ( i - j ) \cdot g ( I ( i - j ) - I ( i ) ) \cdot h ( j )$$
wherein I*(i) is a value of a pixel i of a denoised image produced from the input image I(i) by the denoising process, h(j) is a convolution kernel, and g(I(i)−I(i−j)) is a photometric distance function, and at least one of h(j) and g(I(i)−I(i−j)) is different in the different respective versions of the parameterized image enhancement process corresponding to the image editing process and the emulator process.

6. The method of claim 2, wherein the parameterized image enhancement process comprises a pixel-resolution-dependent local contrast enhancement process that comprises image smoothing based on a pixel-resolution-dependent convolution kernel and local image contrast enhancement based on results of the smoothing, and the convolution kernel is different in the different respective versions of the parameterized image enhancement process corresponding to the image editing process and the emulator proc.

7. The method of claim 1, wherein the image editing process and the emulator process correspond to different respective image enhancement processes that produce similar visually perceptible effects on the first and second images.

8. The method of claim 7, wherein the image editing process is a local contrast enhancement process and the emulator process is an image sharpening process.

9. The method of claim 7, wherein the image editing process is a bilateral filtering process and the emulator process is an image smoothing process.

10. The method of claim 1, wherein the image editing process is defined by a first set of one or more image enhancement functions and the emulator process is defined by a second set of one or more image enhancement functions that is different from the first set of image enhancement functions.

11. The method of claim 11, wherein the first set and the second set consist of different respective numbers of the image enhancement functions.

12. Apparatus, comprising:
a computer-readable medium storing computer-readable instructions; and
a data processor coupled to the computer-readable medium, operable to execute the instructions, and based at least in part on the execution of the instructions operable to perform operations comprising
deriving a second image from a first image, wherein the first image has a first pixel resolution and the second image has a second pixel resolution that is lower than the first pixel resolution;
changing visual elements of the first image in accordance with an image editing process to produce an edited high-resolution image at the first pixel resolution; and
modifying visual elements of the second image in accordance with an emulator process to produce a modified low-resolution image at the second pixel resolution, wherein in the modifying the emulator process produces the modified low-resolution image with visual changes relative to the second image that mimic perceived visual changes made to the visual elements of the first image by the image editing process to produce the edited high-resolution image.

13. The apparatus of claim 12, wherein the image editing process and the emulator process correspond to different respective versions of a parameterized image enhancement process that includes at least one pixel-resolution-dependent parameter that influences how the parameterized image enhancement process changes visual elements of an input image, and the at least one pixel-resolution-dependent parameter is set to different values in the different respective versions of the parameterized image enhancement process.

14. The apparatus of claim 12, wherein the image editing process and the emulator process correspond to different respective image enhancement processes that produce similar visually perceptible effects on the first and second images.

15. The apparatus of claim 12, wherein the image editing process is defined by a first set of one or more image enhancement functions and the emulator process is defined by a second set of one or more image enhancement functions that is different from the first set of image enhancement functions.

16. At least one computer-readable medium having computer-readable program code embodied therein, the computer-readable program code adapted to be executed by a computer to implement a method comprising:
deriving a second image from a first image, wherein the first image has a first pixel resolution and the second image has a second pixel resolution that is lower than the first pixel resolution;
changing visual elements of the first image in accordance with an image editing process to produce an edited high-resolution image at the first pixel resolution; and
modifying visual elements of the second image in accordance with an emulator process to produce a modified low-resolution image at the second pixel resolution, wherein in the modifying the emulator process produces the modified low-resolution image with visual changes relative to the second image that mimic perceived visual changes made to the visual elements of the first image by the image editing process to produce the edited high-resolution image.

17. The at least one computer-readable medium of claim 16, wherein the image editing process and the emulator process correspond to different respective versions of a parameterized image enhancement process that includes at least one pixel-resolution-dependent parameter that influences how the parameterized image enhancement process changes visual elements of an input image, and the at least one pixel-resolution-dependent parameter is set to different value in the different respective versions of the parameterized image enhancement process.

18. The at least one computer-readable medium of claim 16, wherein the image editing process and the emulator process correspond to different respective image enhancement processes that produce similar visually perceptible effects on the first and second images.

19. The at least one computer-readable medium of claim 16, wherein the image editing process is defined by a first set of one or more image enhancement functions and the emulator process is defined by a second set of one or more image enhancement functions that is different from the first set of image enhancement functions.

20. A method, comprising:
applying a first image editing process to each of multiple input images having a first pixel resolution to produce edited high-resolution images at the first pixel resolution;
deriving reduced-resolution versions of the input images having a second pixel resolution that is lower than the first pixel resolution;
processing each of the reduced resolution versions of the reduced-resolutions versions of the input images with a current set of one or more image enhancement processes to produce a respective set of modified low-resolution images at the second pixel resolution;
comparing the modified low-resolution images in the respective set with downsampled versions of the high-resolution images at the second pixel resolution;
repeating the processing and the comparing with a different respective set of one or more image enhancement processes selected as the current set until differences between the modified low-resolution images in the respective set and the downsampled versions of the high-resolution images satisfy a termination predicate; and
after the repeating, outputting the current set of one or more image enhancement processes as elements of a second image editing process;
wherein the applying, the deriving, the processing, the comparing, the repeating and the outputting are performed by a computer.
